(19) United States
(12) Patent Application Publication
(10) Pub. No.: US 2026/0160374 A1
(43) Pub. Date: Jun. 11, 2026

(54) MOTION ACTIVATED SAFETY RELIEF FOR ISOLATION TEST PLUG

(71) Applicant: USA Industries, LLC, South Houston, TX (US)

(72) Inventors: Armando GARZA, Friendswood, TX (US); John Rey De La Cruze DE LEON, Pearland, TX (US); Richard SALLEE, Liberty, TX (US); Bert ANDERSON, Katy, TX (US)

(21) Appl. No.: 19/406,623

(22) Filed: Dec. 2, 2025

Related U.S. Application Data
(60) Provisional application No. 63/730,702, filed on Dec. 11, 2024.

(51) Int. Cl. F16L 55/10; F16L 55/11

(52) U.S. Cl. CPC F16L 55/1022; F16L 55/11

(57) ABSTRACT

The embodiments disclosed herein relate to a safety device for preventing an outward motion of a plug from an opening of the pipe having: a cage having a catch ring and a clamp ring, wherein the catch ring and the clamp ring are connected via a cage support member; wherein the catch ring defines a catch ring opening smaller than the opening of the pipe; wherein the clamp ring is configured to secure to an exterior of the pipe; and a valve, wherein the valve is configured to be actuated from a closed position initially to an open position, and further wherein the valve is connected to the cage and is actuated as a result of the outward motion of the plug.

### BACKGROUND

Technical field: The subject matter generally relates to the field of isolation and test plugs, in particular preventing or mitigating effects of the ejection of isolation or test plugs from pipes, pipelines or pressure vessels.

Hydrotesting, also known as hydrostatic testing, is a procedure used to assess the integrity and strength of pipes, tanks, and other pressure vessels. During this process, various sealing devices such as isolation plugs, paddle blinds, and blind flanges are employed to close off sections of the equipment that are not under test. The equipment is then filled with water or another liquid, which may be dyed to detect leaks, and subjected to pressures higher than its normal operating level. This elevated pressure is maintained for a specified duration to ensure the vessel can endure it without any leaks or structural failures. Hydrotesting is essential for confirming the safety and reliability of pressure-containing components before they are put into service, helping to prevent potential hazards due to weak or defective construction.

Alternatively, high pressure pneumatic tests may be preferred over hydrotesting, on any pipes that must not be exposed to water, or larger diameter pipes. Water exposure via hydrotesting is undesirable on pipes that will be used in cryogenic applications or on liquefied natural gas (LNG) plant piping (including many other applications) as any water left trapped in a void or weld seam would expand while freezing and potentially cause a pipe failure while in use. Pneumatic testing may use compressed air or another gas, such as nitrogen, as the test medium to pressurize the equipment to evaluate the system integrity and performance.

Pressure testing via hydrotesting or pneumatic testing both present inherent risks. Pneumatic testing, however, presents a higher risk due to the compressibility of gases and the corresponding greater stored energy in same. In large piping systems, a large amount of energy can be stored in trapped air pockets from pipe droop or even entrained or entrapped air in the water from the hydrotesting. By way of example, a 400 foot long large piping system, which is not uncommon, could have several cubic feet of trapped air, even if the trapped air is only 1% of the piping system volume. A mere three cubic feet of air at 960 psi, has a potential energy of roughly 1,000,000 Joules or approximately 0.5 pounds of trinitrotoluene, or TNT, and is about 80% as powerful as a stick of dynamite. During pressure testing, the inadvertent or release of any stored energy in the testing medium can result in the sudden ejection or projectile of components in and on the pipe, including any isolation or test plug, and this is particularly dangerous with the higher potential energy in pneumatic testing.

However, there are a lack of suitable solutions for preventing the ejection of components from the pipe, or mitigating the damage from same, in particular isolation or test plugs. Accordingly, there exists a need for the prevention of the ejection or projectile of components in pressure testing systems to catch the component in motion as the component is starting to eject and to safely relieve the stored energy via dissipating the driving pressure, in particular dropping the pressure and energy rapidly or quickly. This is particularly needed for large and/or long piping systems that may have trapped or entrained air.

### BRIEF SUMMARY

The disclosure relates to a safety device for preventing an outward motion of a plug from an opening of the pipe having: a cage having a catch ring and a clamp ring, wherein the catch ring and the clamp ring are connected via a cage support member; wherein the catch ring defines a catch ring opening smaller than the opening of the pipe; wherein the clamp ring is configured to secure to an exterior of the pipe; and a valve, wherein the valve is configured to be from a closed position initially to an open position, and further wherein the valve is connected to the cage and is actuated as a result of the outward motion of the plug.

### BRIEF DESCRIPTION OF THE DRAWINGS

The embodiments may be better understood, and numerous objects, features, and advantages made apparent to those skilled in the art by referencing the accompanying drawings. These drawings are used to illustrate only typical embodiments of this disclosure, and are not to be considered limiting of its scope, for the disclosure may admit to other equally effective embodiments. The figures are not necessarily to scale and certain features and certain views of the figures may be shown exaggerated in scale or in schematic in the interest of clarity and conciseness.

FIG. 1 depicts a front isometric view of an exemplary embodiment of a motion activated safety relief device for a pressure test plug in a pipe.

FIG. 2 depicts a front isometric cross section view of the exemplary embodiment of the motion activated safety relief device in FIG. 1.

FIG. 3 depicts a front isometric view of an alternative exemplary embodiment of a motion activated safety relief device for a pressure test plug in a pipe.

FIG. 4 depicts a front isometric cross section view of the alternative exemplary embodiment of the motion activated safety relief device in FIG. 3.

FIG. 5 depicts a front isometric view of an alternative exemplary embodiment of a motion activated safety relief device for use with a pressure test plug in a pipe, in an inactive state.

FIG. 6 depicts a front isometric cross section view of the alternative exemplary embodiment of the motion activated safety relief device in FIG. 5.

FIG. 7 depicts a front isometric cross section view of the alternative exemplary embodiment of the motion activated safety relief device in FIG. 5, with a tether on the plug valve stem, in an active state.

FIG. 8 depicts a front isometric view of an alternative exemplary embodiment of a motion activated safety relief device for use with a pressure test plug in a pipe.

FIG. 9 depicts a front isometric cross section view of the alternative exemplary embodiment of the motion activated safety relief device in FIG. 8.

### DETAILED DESCRIPTION OF THE EMBODIMENT(S) SHOWN

The description that follows includes exemplary apparatus, methods, techniques, and instruction sequences that embody techniques of the inventive subject matter. However, it is understood that the described embodiments may be practiced without these specific details.

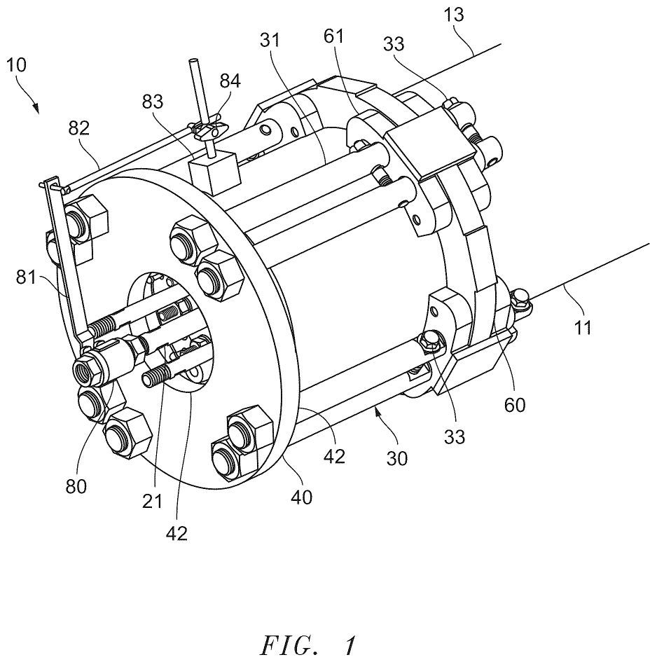

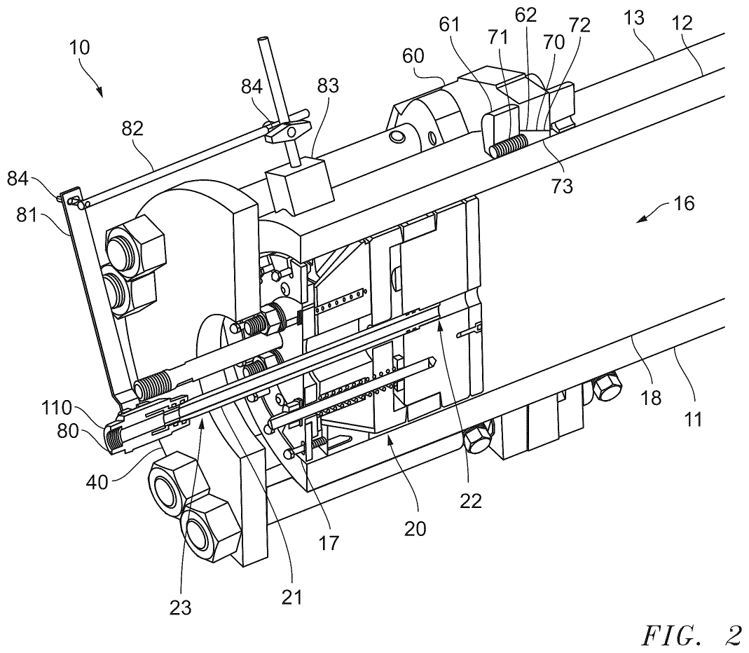

FIGS. 1 and 2 depict views of an exemplary embodiment of a motion activated safety relief device 10 for use with a pressure test plug, isolation device, or other pipe component 20 in a pipe 11. The pipe or tube 11 defines an opening 18 through the length of the pipe 11, and as defined by the interior surface 12 of the pipe 11. The pipe 11 also defines an outer or exterior surface 13. A plug or isolation device 20 or other pipe component 20 may be inserted into the pipe opening 18 from a front or open end 17 of the pipe 11 and maneuvered towards a rear or back 16 of the pipe 11 in preparation for pressure testing. Once the plug 20 is at the desired location in the pipe 11, the operator may actuate or seal the plug 20 to secure the plug 20 position within the pipe 11. The plug 20 may also include one or more vent tubes 21 which traverses through the length of the plug 20 from a front end 22 of the plug 20 to a back end 23 of the plug, and wherein the vent tube 21 defines an opening allowing the flow of a fluid or gas medium. In a conventional plug, the vent tube is closed to allow for the proper pressure testing of the system.

The exemplary embodiment of the motion activated safety device or the safety device 10 may include at least a cage or outer cage 30 having at least one catch or top ring or plate 40; a clamp or clamp ring 60; rods, bars, or cage support members 31 connecting the catch ring or plate 40 and clamp ring 60; and a valve 110. The rods, bars or cage support members 31 may be inserted around the perimeter or rim of each of the rings 40 and 60 and provide axial support for said rings 40, 60 along the length of the cage 30 or between the rings 40 and 60. As depicted in FIGS. 1-2, the exemplary embodiment of the safety device 10 may further include one or more grippers, wedges, or wedge grippers 70 within the clamp ring 60; an actuating arm 81 of the valve 110; a link, chain, or cable 82; and an anchor, base or reference point 83 connected to the link 82. The valve 110 in the exemplary embodiment as shown in FIGS. 1-2 may be, by way of example only, a ball valve 80, but in alternative exemplary embodiments of the safety device 10 may include any other valve 110 that can be actuated by a rotating stem or arm 81.

When the safety device 10 is assembled and in position on the pipe 11, the catch ring 40 is located above the front or open end 17 of the pipe 11. The catch ring or plate 40 may define an opening having an inner diameter 41, and an outer diameter 42, wherein the inner diameter 41 is smaller than the interior surface or inner diameter 12 of the pipe 11. The outer diameter 42 of the catch ring 42 may be larger than the outer diameter 13 of the pipe 11.

The clamp ring 60 is secured to position on the exterior surface 13 of the pipe 11 and is connected to a catch ring 40 via the cage support members 31. The clamp ring 60 may be secured to the pipe 11 via grippers 70 in the exemplary embodiment shown in FIGS. 1-2; in alternative exemplary embodiments, other securing or clamping means may be used to set the clamp ring 60 into the desired fixed position on the pipe 11. The clamp ring 60 may be at least partially secured by the bolts 33 being tightened down to clamp on the pipe 11. The clamp ring 60 is configured to maintain or securely hold the cage 30 onto the pipe 11 through the release of any pressure or energy of the pipe 11 or the outward motion of the plug 20. The clamp ring 60 may include an upper clamp ring 61, into which each stud or gripper stud 71 of the grippers 70 is inserted. Further, the clamp ring 60 may define a slanted, biased, or angled clamp ring interior surface 62 against which the gripper 70 may slidably engage. Each gripper 70 has a tapered surface 72 which may be complementary to and engages the angled clamp surface 62, and an interior surface 73 which faces or engages the pipe 11 exterior surface 13. The gripper interior surface 73 may optionally include a coating or texturing to increase the hold of the gripper 70 on the pipe 11; the hold or grip of the wedge grippers 70 may increase as well if the clamp ring 60 may move towards the open end 17 of the pipe 11 (such as may happen in the event of an isolation device 20 outward motion or ejection). The gripper stud 71 is inserted into the top of each gripper 70, and can maneuver axially within the upper clamp ring or part 61 as the gripper 70 slides against the clamp ring interior surface 62.

A valve 110, such as a ball valve 80, may be connected to a front end 23 of the vent tube 21, wherein the vent tube 21 is in an open or venting position when the safety device 10 is installed onto the pipe 11. The ball valve 80 is in a closed position where there is no motion of the isolation plug 20 during the pressure test. The ball valve 80 has an actuation arm or valve arm 81 which is capable of actuating the ball valve 80 between a closed position and an open position when the arm 81 is rotated away from the pipe 11. The arm 81 is connected, optionally at a pivot 84, to a link, chain, or cable 82 at a first end of the link 82; the second or opposite end of the link 82 is connected, optionally connected at a pivot 84, to a base, anchor, or reference point 83. The base 83 may optionally be a magnetic base secured to the pipe 11 exterior 13, but in alternative exemplary embodiments, the base or anchor 83 may be a strap, hard clamp or other means of affixing the second end of the link 82 to a fixed position on the pipe 11.

To install the exemplary embodiment of the safety device 10 as shown in FIGS. 1-2, the clamp ring 60 inserted over the open end 17 of the pipe 11 which has a plug 20 installed, such as in preparation for a pressure test. The ball valve 80 is affixed onto the vent tube 21 of the plug 20, wherein the vent tube 21 is in an open position. The clamp ring 60 may be further adjusted to the desired location on the pipe 11 exterior 13 and tightened via the fasteners 33. The fasteners 33 aid in maintaining the position of the clamp ring 60. Further, the grit coat or other texture 73 of wedge sections 70 may then be driven into the pipe 11 at the desired location by tightening setscrews 71 or any other actuation device. The setting of the wedges 70 via the set screws 71 forces the grit texture 73 to act like thousands of hardened micro key surfaces to transfer the impact and load forces back into the pipe 11. Before the tightening of the set screws 71, the wedges 70 including grit or texture 73 may act like scotch blocks locking or preventing against reverse motion of the clamp 60 away from the desired location on the pipe 11. The magnetic base or reference anchor point 83 is positioned on the pipe 11, such that the connected actuation valve arm 81 sets the ball valve 80 in a closed position for preventing the flow of air or fluid through the ball valve 80; the arm 81 and base 83 is positioned such that sufficient motion of the valve arm 81 to rotate away from the pipe 11 opens the ball valve 80. The catch ring 40 is positioned adjacent to the open end 17 of the pipe 11.

The safety device 10 as disclosed herein, for all exemplary and alternative exemplary embodiments, is motion activated to catch the plug 20 should the plug 20 eject from the end 17 of the pipe 11, and the safety device 10 will activate with any slippage, motion, or movement of the plug 20 towards the end 17 of the pipe 11, even if the plug 20 does not eject or project from the end 17. In FIGS. 1-2, as the plug 20 moves forward trying to eject from the pipe 11, the magnetic base 83 is connected to the link 82 that pulls on the extended arm 81 of the ball valve 83 to safely release or dump the pressure that is moving the plug 20 out of the pipe 11. As the plug 20 continues to move forward out of the pipe end 17, the plug 20 will be caught by the outer catch ring 40. The catch ring 40 pulls the clamp ring 60, as it is connected by the bars 31 of the cage 30, which causes the gripping wedge conic sections 70 to further clamp down on the pipe exterior 11. The discharging gas or liquid from the activated ball valve 80 also provides some opposite thrust and drops the pressure and stored energy from the inside of the test plug 20. The ball valve 83 may optionally close as the pressure and store energy sufficiently drops from the inside of the test plug 20.

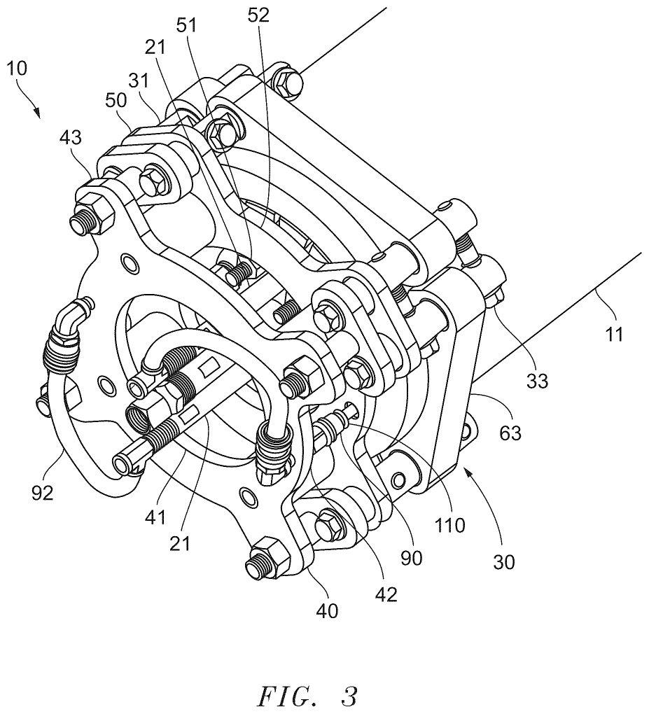

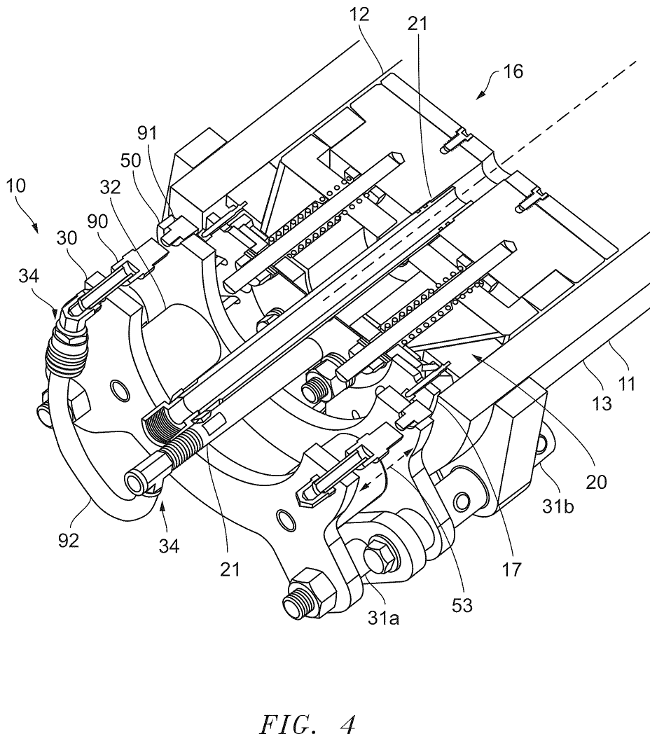

FIGS. 3-4 depict views of an alternative exemplary embodiment of a motion activated safety relief device 10 for a pressure test plug 20 in a pipe 11. The safety release device 10 in FIGS. 3-4, like the exemplary embodiment in FIGS. 1-2, include at least the cage or outer cage 30 having at least one catch or top ring or plate 40; a clamp ring 60; rods, bars, or cage support members 31 connecting the catch ring or plate 40 and clamp ring 60; and a valve 110. The safety release device 10 depicted in the FIGS. 3-4 further includes a middle ring or plate, or a middle catch ring or plate 50; urethane pads or dampers 32; check or needle valves 90; and tubing 92. The clamp ring 60 in the may be composed of individual clamp members 63 encompassing the pipe outer surface 13.

In the alternate exemplary embodiment in FIGS. 3-4, the support members or bars 31 may optionally have a first set of bars 31a and a second set of bars 31b. The bars 31 of the cage 30 may have alternative configurations as described herein and as known to one of ordinary skill in the art to insert into and provide structural support the rings 40, 50, and 60. The first set of bars 31a may connect the catch ring 40 to a supporting plate 54 above the middle plate 50; and the second set of bars or support members 31b may connect the supporting plate 54 and the middle ring 50 to the clamp ring 60 or clamp ring members 63. The cage bars 31b may be inserted into each end of the clamp members 63 and fasteners 33 may connect adjacent or paired cage bars 31b and wherein the fasteners 33 are capable of tightening the cage bars 31b together, or otherwise decrease the distance between the adjacent cage bars 31b or adjacent clamp members 63. This will decrease the inner diameter of the clamp ring 60 or assembled clamp members 63 in order to better secure or maintain the position of the clamp ring 60 or clamp members 63 on the pipe 11 once the safety device 10 is at the desired position on the pipe 11.

Similar to the top ring or first catch ring 40, the middle ring or middle catch plate 50 may also define an opening having an inner diameter 51, and an outer diameter 52, wherein the inner diameter 51 is smaller than the interior surface or inner diameter 12 of the pipe 11. When the safety device 10 is installed onto the pipe 11, the middle ring 50 and top catch ring 40 may both be located above the open end 17 of the pipe 11 in which the plug or isolation device 20 is inserted, and the middle ring 50 may move towards the catch ring 40 provided by an outward motion of the plug 20 engaging the middle ring 50.

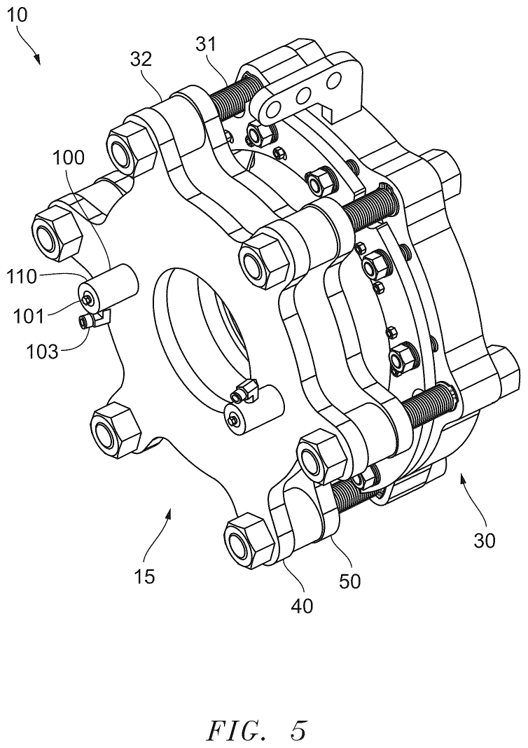

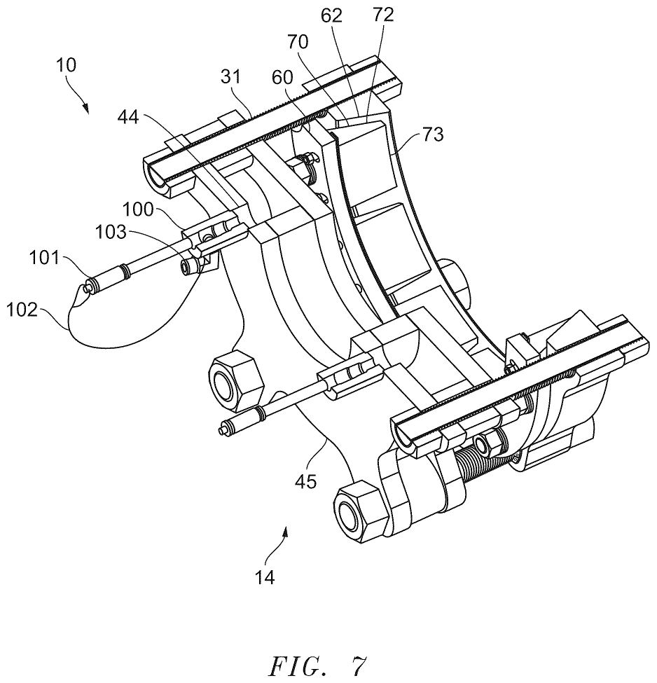

Urethane pads or dampers 32 may be composed of a flexible, compressible material capable of both being compressed and reforming after compression. The dampers 32 are positioned between the catch ring 40 and the middle ring 50, and may optionally be mounted around the cage rods, bars, or support members 31 (see e.g. FIGS. 5-7).

In the alternative exemplary embodiment of the safety device 10 as depicted in FIGS. 3-4, the open vent tube 21 of the plug 20 is connected to a check valve 90 via a tubing 92. The tubing 92 is connected to the open vent tube 21 at the first end of the tubing 92, and the second, other or opposite end of the tubing 92 is connected to a check valve 90, wherein the tubing 92 may be inserted through the catch ring 40. The check valve 90 may be embedded or fixed into the catch ring 40, or alternatively, positioned on the rear side or surface 43 of the catch ring 40. An actuation pin or check valve pin 91 is secured to the middle ring 50, and positioned opposite to the check valve 90 such that the pin 91 may engage the check valve 90 as the middle ring 50 approaches the catch ring 40 when the safety device 10 activates; when the actuation pin 91 engages the check valve 90, the check valve 90 opens to allow the flow of air or fluid through the vent tube 21, the tubing 92 and the check valve 90. When the safety device 10 is in an inactive position, the distance 53 between the catch ring 40 and middle ring 50 is greatest and the actuation pin 91 does not engage the check valve 90; the distance 53 decreases as the safety device 10 is activated and the middle ring 50 approaches the catch ring 40. Connectors or adaptors 34 may be used to connect or secure the tubing 92 to the vent tube 21 and/or the tubing 92 to the check valve 90 and allow the flow of air or fluid through same. The check valve 90 may be built into a hydraulic break away fitting. However, any type of valve 110 may be used if the actuation pin or link 91 is aligned with the valve 110 to operate or actuate the valve 110 to an open position once contact is made between the valve 110 and the pin or link 91.

Installation of the alternative exemplary embodiment of the safety device 10 in FIGS. 3-4 also begins with the clamp ring 60 or clamp ring members 63 being inserted over the open end 17 of the pipe 11 which has a plug 20 within. The tubing 92 is secured to the vent tube 21 of the plug 20, while the vent tube 21 is in an open position. The plug 20 may have multiple vent tubes 21, and thus the safety device 10 may include multiple tubing 92, check valves 90 and actuation pins 91 for connecting to the appropriate or corresponding number of vent tubes 21; this may be varied as dependent on the vent tubes 21 on the particular plug or isolation device 20 (see, by way of example only, plug 20 of FIGS. 1-2 having a singular vent tube 21, and plug 20 of FIGS. 3-4 having two vent tubes 21). The clamp ring 60 or clamp members 63 may be further tightened via the fasteners 33 drawing the bars 31 closer together, to secure on the pipe exterior 13 once at the desired position. The middle ring 50 and the catch ring 40 should be above the opening 17 of the pipe 11.

In FIGS. 3-4, as the plug 20 begins to move out from the end 17 of the pipe 11, the top of the plug 20 will contact and engage the bottom or rear surface of the middle ring 50 and push the middle ring 50 towards the catch plate 40. A portion of the pressure exerted by the moving plug 20 is dampened by the urethane pads or dampeners 32 between the rings 40 and 50 as these rings 40 and 50 compress. As the distance 53 between the middle ring 50 and the catch ring 40 decreases, the actuation pin 91 contacts or engages check valve 90 and actuates or opens the check valve 90 to allow the flow of air or fluid through the vent tube 21, tubing 92, and the check valve 90 to further relieve pressure from the pipe 11 and plug 20. The greater the number of vent tubes 21 that are connected to tubing 92 and check valves 90 which are open, the faster the pressure may be relieved from the pipe 11 and plug 20. When sufficient pressure is relieved, and the danger of sudden projection of the plug 20 is no longer present, the dampeners 33 may begin to uncompress and regain their inactive state, and force the middle ring 50 away from the catch ring 40, increasing the distance 53 once again. The discharging gas or liquid from the activated check valve 90 also provides some opposite thrust and drops the pressure and stored energy from the inside of the test plug 20. Once there is sufficient distance 53 between the rings 40, 50, and the actuation pin 91 disengages from the check valve 90, the check valve 90 will revert back to a closed position thus closing the flow of air or fluid from the tubing 92 and the vent tube 21 as well. The motion activated safety device 10 as shown in FIGS. 3-4 may be kept on the pipe 11 for additional testing as needed as it has fully reset back to an inactive state.

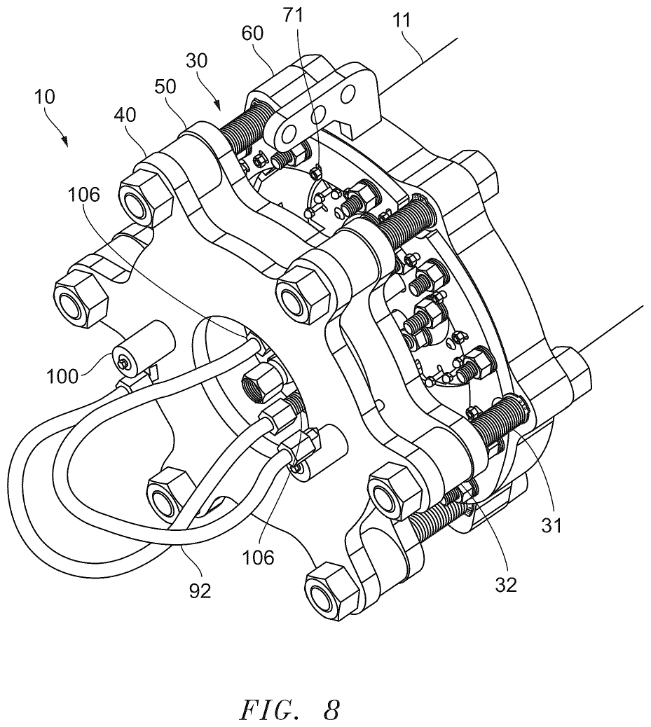

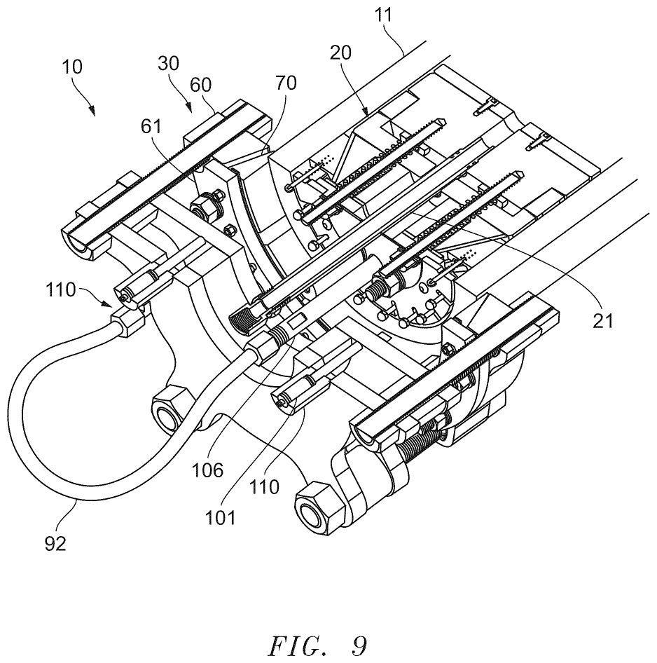

FIGS. 5-7 depict a further alternative exemplary embodiment of a motion activated safety relief device 10 for use with a pressure test plug 20 in a pipe 11. The safety device 10 depicted in FIGS. 5-7 include at least the cage or outer cage 30 having at least one catch or top ring or plate 40; a clamp ring 60; rods, bars, or cage support members 31 connecting the catch ring or plate 40 and clamp ring 60; and a valve 110. The alternative exemplary embodiment of the safety device 10 in FIGS. 5-7 further includes a middle ring or plate, or a middle catch ring or plate 50; urethane pads or dampers 32; grippers 70; and plug valves or valve fittings 100 with corresponding plug valve stems or push pins 101 and plug valve tethers 102. The plug valves or valve fittings 100 may each be separately connected to fill and drain tubes 106 as shown in FIGS. 8-9 via tubing 92, but may, in further alternate exemplary embodiments, be connected to a tee fitting on the center vent tube or pipe 21. The fill and drain tubes 106 may not be present on smaller sized plugs 20. On larger sized plugs 20, the valves 110 connected to the center vent tube 21 or these other, additional, vent or fill and drain tubes 106, which provides a similar way of dumping or relieving the pressure. In certain exemplary embodiments, the valves 110 may be connected to both kinds of vent tubes 21 and vent tubes 106. Larger plugs 20 may require an additional number valves 110 and connection lines or tubes 106 to dissipate the energy quick enough to provide protection for the correspondingly larger pipe 11 and plug 20.

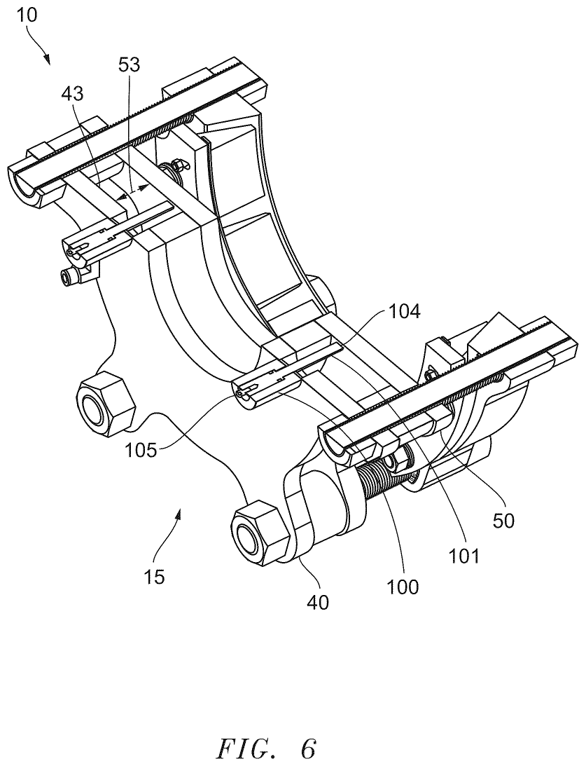

The catch ring 40 in the alternative exemplary embodiment of the safety device 10 as depicted in FIGS. 5-7 may define one or more ports 44 for connecting to a plug valve or valve fitting 100, wherein the valve fitting 100 is located more towards or on a top surface 45 of the catch ring 40. A plug valve stem 101 is inserted into the top of the plug valve 100, wherein the length of the plug valve stem 101 is greater than that of the plug valve 100, such that a rear end 104 of the valve stem 101 extends beyond the valve fitting 100 and beyond the rear surface 43 of the catch ring 40 towards the middle ring 50 when the valve stem 101 is initially installed. When the safety device 10 is in an inactive state 15, as shown in FIGS. 5-6, the middle ring 50 does not contact or engage the valve stem 101. Further, when the plug valve stem 101 is inserted in the plug valve 100, the plug valve 100 is closed to the flow of air and fluid and is inactive. Upon compressing the middle ring 50 towards the catch ring 50, the valve stem 101 is ejected out of the valve fitting 100 by the middle ring 50 and each plug valve 100 is open until the pressure and stored energy is released from the pipe 11 and plug 20. The plug valve 100 may also have a tether point or extension 103 to which a tether 102 is connected at one end of the tether, and wherein the second end of the tether is connected to a top end 105 of the plug valve stem 101 such that the stem 101 remains connected to the safety device 10 even if the stem 101 has been ejected out of the valve fitting 100. In alternative exemplary embodiments, the tether point 103 may be located elsewhere on the safety device 10 for connecting or anchoring the tether 102 (such as, by way of example only, the top surface 45 of the catch ring or plate 40).

The middle ring 50, clamp ring 60, cage 30, grippers 70 and dampeners 32 of the alternative exemplary embodiment of the safety device 10 in FIGS. 5-7 may be located and perform similarly or approximately as described for earlier embodiments in this disclosure, including installation of the clamp ring 60 and grippers 70 on the pipe 11 exterior 13, and placement of the middle ring or middle catch ring 50 and catch ring 40 above the open end 17 of the pipe 11, and wherein the middle ring 50 and catch ring 40 each define openings smaller than the interior diameter 12 of the pipe 11, and smaller than the plug 20.

In FIGS. 5-7, if the plug 20 begins to move out from the end 17 of the pipe 11, the top of the plug 20 will contact and engage the bottom of the middle ring 50 and push the middle ring 50 axially towards the catch plate 40. A portion of the pressure exerted by the moving plug 20 is dampened by the urethane pads or dampeners 32 between the rings 40 and 50 as these rings 40 and 50 compress. Moreover, as the distance 53 between the middle ring 50 and the catch ring 40 decreases, the middle ring 50 will also engage against the end 104 of the valve stem 101, which will eject the stems 101 from the plug valves 100, as the stems 101 absorb the pressure and energy from the middle plate 50 being pushed or maneuvered by the moving plug 20, and resulting in the activated state 14 of the safety valve 10. The removal of the stems 101 from the valves 100 allow the pressure and stored energy from the pipe 11 and plug 20 to be safely dissipated through the open valves 100. Each of the stems 101 will remain connected to the safety device 10 via tethers 102, despite being ejected from the valves or valve fittings 100. Once sufficient pressure and energy is relieved, an operator can manually reinsert the stems or pins 101 back into the fittings 100.

Exemplary embodiments of the safety device 10 described herein may include combinations of one or more of the following: a ball valve 80 having an arm 81 linked to an anchor 83; and/or a check valve 90 on the catch ring 40 with an actuation pin 91 on an adjacent or middle ring 50; and/or ejecting pins 101 within a valve fitting 100. These exemplary embodiments may also optionally include: wedge grippers 70 on the clamp ring 60, and/or urethane pads 32 between any of the rings 40, 50, 60. Exemplary embodiments of the safety device 10 may include the catch ring 40 and a clamp or clamp ring 60 as connected through a cage 30 having support bars 31 and/or support plates 54 and/or fasteners 33 - one or more middle rings 50 may be included between the top ring 40 and the clamp ring 60; alternatively, middle rings 50 may be omitted. Any slipping, slippage or movement of the plug or isolation device 20 out of the pipe 11 will trigger the exemplary embodiments of the safety devices 10 to activate and relieve pressure and energy from the moving plug 20, even if the plug 20 is not immediately ejecting with projectile force.

By way of example only, please refer to FIGS. 8-9 which depict a further alternative exemplary embodiment of the motion activated safety device 10 for a pipe 11 which contains a plug 20. The safety device 10 in FIGS. 8-9 has a cage 30 with bars 31 that connect the catch ring 40, the middle ring 50, and the clamp ring 60. The cage 30 also includes dampeners 32 between the catch ring 40 and the middle ring 50, as mounted around the bars 31. The clamp ring 60 further includes wedge grippers 70 and an upper clamp ring 61 for housing the gripper studs 71. The motion activated safety device 10 in FIGS. 8-9 includes the safety relief valve 110 as plug valves 100 having ejectable pins 101. Tubing 92 connects each plug valve 100 to each vent tube 21 or fill and drain tube 106 at the ends of the tubing 92.

While the exemplary embodiments are described with reference to various implementations and exploitations, it will be understood that these exemplary embodiments are illustrative and that the scope of the inventive subject matter is not limited to them. Many variations, modifications, additions, and improvements are possible.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

1. A safety device for relieving a pressure or an energy from an outward motion of a plug from an opening of the pipe, comprising:
a cage having a catch ring and a clamp ring, wherein the catch ring and the clamp ring are connected via a cage support member;
wherein the catch ring defines a catch ring opening smaller than the opening of the pipe;
wherein the clamp ring is configured to secure to an exterior of the pipe; and
a valve, wherein the valve is configured to be actuated from a closed position initially to an open position, and further wherein the valve is connected to the cage and is actuated as a result of the outward motion of the plug.

2. The apparatus of claim 1, wherein the cage further comprises a middle ring between the catch ring and the clamp ring, wherein the middle ring is connected via the cage support member to the catch ring and the clamp ring, and wherein the middle ring defines a middle ring opening smaller than the opening of the pipe.

3. The apparatus of claim 2, wherein the valve comprises a valve fitting on the catch ring; and a valve stem inserted through the valve fitting and extending past a rear surface of the catch ring.

4. The apparatus of claim 3, further comprising a tether connected at a first end of the tether to the valve stem.

5. The apparatus of claim 2, wherein the valve comprises a check valve connected to the catch ring and an actuation pin mounted on the middle ring.

6. The apparatus of claim 5, further comprising a tubing connected to the check valve at a first end of the tubing and to a vent tube of the plug at a second end of the tubing.

7. The apparatus of claim 1, wherein the clamp ring further comprises one or more wedge grippers slidable against an interior surface of the clamp ring.

8. The apparatus of claim 7, wherein the interior surface of the clamp ring is angled, and further comprising a tapered surface defined on the one or more wedge grippers, wherein the tapered surface slides against the interior surface of the clamp ring.

9. The apparatus of claim 8, further comprising an upper clamp ring and a stud inserted into the one or more wedge grippers and through the upper clamp ring.

10. A method for relieving a pressure or an energy from an outward motion of a plug from an opening of the pipe, comprising the steps of:
providing a cage for the pipe, wherein the cage comprises a catch ring connected to a clamp ring, wherein the catch ring and the clamp ring are connected by at least one cage support member; and a valve connected to the cage, wherein the valve is initially in a closed position of the valve before the outward motion of the plug;
securing the clamp ring to an exterior surface of the pipe;
positioning the catch ring above the opening of the pipe;
actuating the valve to an open position of the valve as a result of the outward motion of the plug to relieve the pressure or the energy.

11. The method according to claim 10, wherein the cage further comprises a middle ring between the catch ring and the clamp ring, and wherein the step of actuating the valve to the open position is via the step of moving the middle ring towards the catch ring.

12. The method according to claim 11, further comprising the step of engaging the plug against the middle ring.

13. The method according to claim 12, wherein the step of actuating the valve to the open position comprises the steps of engaging the middle ring against a valve stem inserted through a valve fitting located on the catch ring; and ejecting the valve stem from the valve fitting.

14. The method according to claim 13, further comprising the step of compressing a dampener between the catch ring and the middle ring as a result of the outward motion of the plug.

15. The method according to claim 14, further comprising the steps of moving the middle ring away from the catch ring upon sufficient relief of the pressure or the energy; uncompressing and reforming the dampener; and resetting the valve to the closed position of the valve.

16. The method according to claim 10, wherein the clamp ring further comprises an angled interior surface and a wedge gripper having a tapered surface slidable against the angled interior surface of the clamp ring; and further comprising the step of increasing a hold of the wedge gripper against the exterior surface of the pipe as a result of the outward motion of the plug.

17. A safety device for releasing a pressure or an energy from an outward motion of a plug from an opening of the pipe, comprising:
a cage having a catch ring and a clamp ring, wherein the catch ring and the clamp ring are connected via a cage support member;
a middle ring between the catch ring and the clamp ring, wherein the middle ring is connected via the cage support member to the catch ring and the clamp ring;
wherein the clamp ring is configured to secure the cage to an exterior of the pipe despite the pressure or the energy release;
a valve, wherein the valve is configured to be actuated from a closed position initially to an open position;
wherein the valve comprises a valve fitting on the catch ring and a valve stem inserted through the valve fitting and extending past a rear surface of the catch ring; and
a tubing connecting the valve fittings to the plug.

18. The apparatus according to claim 17, further comprising a flexible dampener between the catch ring and the middle ring.

19. The apparatus according to claim 18, wherein the clamp ring further comprises one or more wedge grippers slidable against an interior surface of the clamp ring.

20. The apparatus according to claim 19, further comprising an active state of the safety device wherein the flexible dampener is compressed between the catch ring and the middle ring; wherein the valve stem is ejected from the valve fitting and the valve fitting is in the open position for the valve, in the active state of the safety device.
